(19) United States
(12) Patent Application Publication
(10) Pub. No.: US 2004/0052202 A1
(43) Pub. Date: Mar. 18, 2004

(54) RFID enabled information disks

(76) Inventor: Brian W. Brollier, Cincinnati, OH (US)

Correspondence Address: Lorri W. Cooper, Esq., JONES, DAY, REAVIS & POGUE, North Point, 901 Lakeside Avenue, Cleveland, OH, 44114, US

(21) Appl. No.: 10/242,964

(22) Filed: Sep. 13, 2002

(51) Int. Cl. G11B 3/70; G11B 5/84; G11B 7/26; G11B 33/02; G08B 13/14

(52) U.S. Cl. 369/273; 340/572.7; 369/77.1

(57) ABSTRACT

An information disk includes an annular disk structure having a surface with a metalized data storage area coupled to the surface. An antenna is affixed to the disk surface and positioned radially inwardly from the metalized data storage area. A radio frequency identification processor is coupled to the disk surface and the antenna. A non-conductive gap is positioned between the metalized data storage area and the antenna and the processor is positioned in the gap. A protective coating is positioned on the disk structure The processor may also be positioned radially inwardly from the antenna. A process for enabling an information disk with a radio frequency identification processor is also described. The process includes providing a disk with an outer metalized data storage portion and an inner antenna portion, with the portions separated by a gap for accommodating a processor. The process also includes positioning the processor in the gap so that the processor is electrically active, and coating the disk with a protective coating to cover the surface of the disk.

### FIELD OF THE INVENTION

This invention relates to wireless communication systems. In particular, the invention relates to the implementation of radio frequency identification apparatus in information media for use with systems to prevent the unauthorized use of copyrighted or otherwise secured work.

### BACKGROUND

Radio frequency identification (RFID) technology has been used for wireless automatic identification. An RFID system typically includes a transponder, also referred to as a tag, an antenna, and a transceiver with a decoder. The tag includes a radio frequency integrated circuit and the antenna serves as a pipeline between the circuit and the transceiver. Data transfer between the tag and transceiver is wireless. RFID systems may provide non-contact, non-line of sight communication.

RF tag “readers” utilize an antenna as well as a transceiver and decoder. When a tag passes through an electromagnetic zone of a reader, the tag is activated by the signal from the antenna. The transceiver decodes the data on the tag and this decoded information is forwarded to a host computer for processing. Readers or interrogators can be fixed or handheld devices, depending on the particular application.

RFID systems may utilize passive, semi-passive, or active transponders. Each type of transponder may be read only or read/write capable. Passive transponders obtain operating power from the radio frequency signal of the reader that interrogates the transponder. Semi-passive and active transponders are powered by a battery, which generally results in a greater read range. Semi-passive transponders may operate on a timer and periodically transmit information to the reader. Active transponders can control their output, which allows them to activate or deactivate apparatus remotely. Active transponders can also initiate communication, whereas passive and semi-passive transponders are activated only when they are read by another device first. Multiple transponders may be located in a radio frequency field and read individually or simultaneously.

### SUMMARY

According to the invention, an information disk comprises an annular disk structure, an antenna, and a radio frequency identification processor. The annular disk structure has a surface with a metalized data storage area for storing information. The antenna is affixed to the annular disk surface and positioned radially inwardly from the metalized data storage area. The radio frequency identification processor is coupled to the annular disk surface and to the antenna. A protective coating is coupled to at least one of the processor or the antenna.

In another embodiment, a system for reading an information disk includes the information disk described above and a reader. The reader has two coupling plates, with one coupling plate electrically interacting with the antenna, and the other coupling plate electrically interacting with the metalized data storage area to activate the dipole inductive processor.

In yet another embodiment, a process for enabling an information disk with a radio frequency identification processor is provided. This process includes providing a disk having a disk surface with an outer metalized data storage portion and an inner antenna portion separated by a gap for accommodating a radio frequency identification processor. The processor is positioned in the aforementioned gap such that it is electrically active. The disk is coated to cover the disk surface. The coating step includes coating at least the antenna portion, the gap, the processor, and the metalized data storage portion.

An alternative embodiment also concerns a process for enabling an information disk with a radio frequency identification processor. This process includes providing an annular disk having a surface with an outer metalized data storage portion and an inner antenna portion, with the inner and outer portions being separated by a non-conductive gap, the gap being dimensioned to accommodate a processor. The process also includes positioning the processor radially inwardly from the antenna portion on the disk surface such that the processor is electrically coupled to the antenna, and coating the disk with a coating to cover the disk surface.

In another embodiment, the process of enabling an information disk with a processor includes providing a disk having a surface with an outer metalized data storage portion around the outer periphery thereof and an inner portion, positioning a loop-type antenna on the inner portion of the disk surface, positioning a processor having a first and a second terminal in association with the loop-type antenna, and coating the disk with a protective layer. The loop-type antenna has a first and a second pole. The first terminal of the processor is associated with the first pole of the loop-type antenna and the second terminal of the processor is associated with the second pole of the loop-type antenna.

In yet another embodiment, a process for enabling an information disk with a radio frequency processor includes embedding a radio frequency processor in a disk structure, and metalizing the disk structure over the processor to form a data storage area and an antenna such that the processor is electrically associated with at least one of the antenna and the data storage area. The process may further include coating the disk with a coating.

In another embodiment, an information disk is provided that has a rigid disk structure and a processor. The disk structure has a surface with a first metalized portion and a second metalized portion with a gap positioned therebetween. The processor is positioned at least partially in the gap such that the processor is electrically coupled to at least one of the first or second metalized portions. An interposer may be associated with the radio frequency processor and the interposer is positioned at least partially in the gap. The processor is connected to the interposer. The disk structure may be annular with the first metalized portion being positioned near the outer periphery of the disk structure and the second metalized portion being positioned radially inwardly from the first metalized portion.

In another embodiment of the information disk, the disk includes a rigid, annular disk structure having a surface with a central opening and a metalized data storage area positioned on the surface for storing information. A radio frequency identification processor is coupled to the annular disk surface positioned radially inwardly from the metalized data storage area.

Alternatively, the information disk may include an annular disk structure having an annular disk surface with an outer metalized portion and an inner metalized portion. An annular gap is positioned between the portions. A processor is positioned radially inwardly from the inner metalized portion. The processor is electrically coupled to the inner metalized portion.

### BRIEF DESCRIPTION OF THE DRAWING FIGURES

FIG. 1 is an elevated top view of an embodiment of the RFID enabled information disk of the claimed invention utilizing a capacitive antenna system;

FIG. 2 is an expanded partial cross-sectional view of the disk structure shown in FIG. 1, taken at line 2-2, for a CD construction;

FIG. 3 is an expanded partial cross-sectional view of the disk structure shown in FIG. 1 depicting an alternative embodiment of a CD construction where a recess is sized to accept an RFID processor, or the processor is otherwise embedded in the disk surface, again taken at line 2-2 in FIG. 1;

FIG. 4 is an expanded partial cross-sectional view similar to that of FIG. 3, but showing the metalized areas positioned under the processor in the recess;

FIG. 5 is an expanded partial cross-sectional view of the disk structure of FIG. 1 for a CD construction, depicting an alternative embodiment where an interposer is positioned between the processor and the metalized areas, taken at line 2-2 in FIG. 1;

FIG. 6 is an expanded partial cross-sectional view of the disk structure of FIG. 1 for a CD construction, depicting an alternative embodiment where the conductive areas on the disk surface are covered by a non-conductive layer, and an interposer and chip are positioned for capacitive coupling with the conductive areas;

FIG. 7 is an expanded partial cross-sectional view of the disk structure of FIG. 1, similar to FIG. 6, but without the non-conductive layer;

FIG. 8 is an expanded partial cross-sectional view of the disk structure of FIG. 1, showing a DVD construction having two disk layers that are bonded together, with the processor positioned in a recess in one of the disk layers and the metalized areas extending into the recess, again taken at line 2-2 of FIG. 1;

FIG. 9 is an expanded partial cross-sectional view similar to that of FIG. 8, but showing a recess formed in both disk layers of the DVD and with a layer of bonding material positioned between the disk layers;

FIG. 10 is an expanded partial cross-sectional view similar to that of FIG. 8, but without any recesses being formed in the disk layers and with the processor positioned between and embedded in the bonding material utilized to join the two disk layers together;

FIG. 11 is a schematic perspective view of a reader for reading a capacitive or inductive RFID processor using a capacitive antenna system, with components of the reader positioned over an information disk;

FIG. 12 is an elevated top view of an alternative embodiment of the disk structure utilizing a capacitive antenna system;

FIG. 13 is an elevated top view of an alternative embodiment of the disk structure shown utilizing an inductive antenna system;

FIG. 14 is an expanded partial cross-sectional view of the disk structure for a CD construction shown in FIG. 13, taken at line 14-14;

FIG. 15 is an expanded partial cross-sectional view of the disk structure shown in FIG. 13 for a CD construction depicting an alternative embodiment where a recess is sized to accept an RFID processor, or the processor is embedded in the surface of the disk structure, again taken at line 14-14;

FIG. 16 is an expanded partial cross-sectional view similar to FIG. 14, but depicting a DVD construction where an RFID processor is bonded between two disk layers;

FIG. 17 is an elevated top view of an alternative embodiment of the disk structure showing an interposer and processor positioned adjacent the metalized data storage area on the disk structure;

FIG. 18 is an expanded partial cross-sectional view of the disk structure shown in FIG. 17, taken at line 18-18 for a CD construction

FIG. 19 is an expanded partial cross-sectional view similar to that shown in FIG. 18, but including a non-conductive layer between the metalized data storage area and interposer for a CD construction;

FIG. 20 is an elevated top view of an alternative embodiment of the disk structure showing an inductive antenna system utilizing a loop antenna;

FIG. 21 is an expanded partial cross-sectional view of the disk structure shown in FIG. 20, taken along line 21-21, for a CD construction;

FIG. 22 is an expanded partial cross-sectional view of an alternative disk structure shown in FIG. 20, taken along line 21-21, for a CD construction;

FIG. 23 is an elevated top view of an alternative embodiment of the disk structure showing an inductive antenna system;

FIG. 24 is an expanded partial cross-sectional view of the disk structure shown in FIG. 23, taken along line 24-24, for a CD construction;

FIG. 25 is an expanded partial cross-sectional view of an alternative embodiment of the disk structure shown in FIG. 23, taken along line 24-24, for a CD construction;

FIG. 26 is an elevated top view of an alternative embodiment of the disk structure showing the processor positioned in the area defined for the coils of a loop antenna;

FIG. 27 is an expanded partial cross-sectional view of the disk structure shown in FIG. 26, taken along line 27-27, for a CD construction;

FIG. 28 is an expanded partial cross-sectional view similar to that of FIG. 27 for a CD construction, but with the antenna positioned over the processor;

FIG. 29 is an elevated top view of an alternative embodiment of the disk structure showing a dipole antenna in conjunction with a processor;

FIG. 30 is an elevated top view of an alternative embodiment of the disk structure showing a folded dipole antenna in conjunction with a processor; and

FIG. 31 is an elevated top view of several alternative embodiments of the disk structure showing a processor having an onboard antenna embedded in the disk structure at a variety of locations.

### DETAILED DESCRIPTION

An information disk 10 with an associated radio frequency identification (RFID) processor 22 is shown in FIGS. 1-30. The RFID processor may be energized to provide a radio frequency signal that can be used to prevent unauthorized copying of copyrighted or otherwise secured information on the information disk. The processor can be associated with any type of information disk, whether the disk comprises a single disk, as in the case of a compact disk (“CD”), or multiple laminated disks, as in the case of a Digital Versatile Disk (“DVD”).

The present design uses standard CD and DVD construction and positions a processor 22 on the disk 10. A CD has an annular, substantially rigid, disk structure 10 approximately 12 centimeters in diameter and 1.2 millimeters thick, with an approximately 1.6 centimeter diameter central opening 12, also called a hub. CDs are typically made from a polycarbonate base 11 in an injection molding process. During molding, data in the form of tiny pits in a spiral pattern are formed in the surface 14 of the disk base 11, and the data portion on the surface 14 of the base 11 is then coated with a thin layer of metal to form a metalized data storage area 16. A typical coating material is aluminum, copper, or gold. The data storage area 16 is typically a ring-shaped area that is concentric to the annular disk structure, with an inner diameter of approximately 4.125 centimeters and an outer diameter of approximately 11.75 centimeters. The data storage area 16 preferably does not extend to the outer periphery 18 of the disk structure 10, leaving a thin non-metalized annular ring 20 at the outer periphery 18 and an annular portion at the center of the disk 10. The data stored on the CD (the spiral trail of tiny pits) may be read by a laser in a player.

The entire disk surface 14 of the base 11 is covered by a transparent protective coating, such as acrylic or nitrocellulose, to protect the metalized data storage area 16. The interior annular non-conductive portion of the CD (between the data storage area 16 and the central opening 12), previously did not contain any information aside from occasional printed information. A processor 22, such as an RF chip having an integrated circuit, is now positioned on the surface 14 of the base 11 in the interior area. The processor 22 is associated with an antenna 28, which may also be positioned on the disk surface 14 in the interior area. The processor 22 is electrically active and can be activated by an RF reader positioned near the surface 14 of the CD inside a player. The processor 22 may be positioned in a variety of positions on the disk surface 14, which will each be discussed in connection with the respective figures.

DVDs have approximately the same physical dimensions as the CDs discussed above, but include multiple data storage areas 16, such as two disk layers 24 that are 0.6 millimeters thick. The metalized data storage areas 16 on each layer 24 of a DVD are parallel to each other. An additional reflective layer may be positioned between the disk layers in the vicinity of the metalized data storage area 16. This reflective layer may be a non-conductive material, such as the material that is used to bond the two disk layers 24 together. DVDs can store more information than CDs because data is stored in a tighter spiral or pattern than the data of a CD, and due to the multiple data layers on the DVDs.

Like CDs, DVDs-are formed using an injection molding process. In one such process, two molds are utilized to make a single DVD. Each mold produces a 0.6 mm disk layer 24. A plastic material, such as polycarbonate, is heated to a molten state and fed into the mold. The plastic layer 24 is compressed in the mold under several tons of pressure so that the pits corresponding to the data are formed in the plastic disk layers 24. The clear plastic layers are then chilled and removed from the mold. After each layer 24 is pressed, the data area on the disk layers 32 are coated with a metallic layer to cover the pits to form the metalized data storage area 16. A preferred coating technique is sputter coating and preferred materials are aluminum, copper, or gold. The two disk layers 24 are then bonded together with a bonding material, such as lacquer, and UV light is applied as the disks are squeezed together. The exterior surfaces of the disk layers 24 may also be coated with a protective coating 26. A processor 22 and an antenna 28 are positioned on the disk between the two disk layers 24. Alternatively, the processor and/or antenna may be positioned on an exterior surface of the DVD.

The term “processor” as used herein refers generally to a computer that processes or stores information, such as a computer chip. The processor may include a semiconductor circuit having logic, memory, and RF circuitry. It may include a computer chip in conjunction with an interposer, a computer chip in conjunction with leads for attaching the computer chip to conductive materials, or simply a computer chip with terminals for electrical connection with conductive materials. The computer chip may be a silicon-based chip, a polymer based chip, or other chips that are known today or will be developed in the future. In addition, the term “processor” includes new “chipless” technology, such as that manufactured by Checkpoint, where information is stored on an RFID chip and the information can be read by a reader; “flip chips” that include bridging connectors built directly into the chip; or other chips that include substrates that act like interposers. Thus, the term “processor” as used herein is meant to encompass a variety of embodiments and configurations.

Referring to the figures, the present design utilizes the surface 14 of a CD or DVD and positions a processor 22 and an antenna 28 on the surface 14. In particular, the design uses the currently unused inner surface area of the disk to create a conductive area. As shown in the figures, the disk 10 has an outer metalized data storage area 16 and an inner metalized area 28 that is separated from the outer metalized data storage area 16 by an annular ring or gap 30 that is not conductive. The inner metalized area 28 serves as an antenna and may be structurally formed on the existing surface 14 of the disk 10. The antenna 28 can take on various forms depending on the type of RFID processor used. In addition, the antenna 28 may be any type of conductive material, for example, such as copper or gold. While the inner area is referred to herein as the inner metalized area 28, it may include materials other than metal, as long as the materials are conductive. In addition, as will be discussed in greater detail below in connection with several embodiments, it is not necessary that the entire inner area be conductive. Several embodiments involve small parts of the inner area to define a conductive area. Other embodiments do not require that any part of the inner area be metalized. Further, the term metalized also includes antennas that are preformed and are positioned on the inner surface.

As discussed above, the RFID system of the present design includes an RFID processor 22 and an antenna system. In one embodiment, the RFID processor 22 is positioned between the metalized data storage area 16 and the inner metalized area in the gap 30. The processor 22 may alternatively be positioned in the outer metalized data storage area 16, the outer non-metalized ring 20, or the inner antenna area 28. The RFID processor can be of the type that utilizes a capacitive antenna system or an inductive antenna system. A processor having an onboard antenna may also be utilized. The processor 22 may be capacitively coupled to the antenna system or may be physically connected to the antenna system utilizing a lead, trace, or other connector.

Referring to FIGS. 1-10, the disk 10 has a base 11 that includes a disk surface 14. The metalized data storage area 16 is positioned on the surface 14 around the outer periphery 18 of the disk. An opening 12 is positioned in the center of the disk 10, an inner metalized area 28 is positioned on the disk surface 14 at a position spaced radially inwardly from the outer data storage area 16, and a gap 30 is positioned between the outer and inner metalized areas 16, 28. The inner metallized area 28 serves as an antenna. The terms “inner metalized area” and “antenna” are used broadly herein and interchangeably to refer to any type of antenna that is formed by any known or described method. Gap 30 is non-conductive and, as shown in FIGS. 1-10, is on the disk surface 14. The processor 22 is positioned at least partially in the gap 30 and is coupled to both the inner 28 and outer 16 metalized areas. The processor may be coupled capacitively, or may be physically attached to one or both of the metalized portions 16, 28. Each of the RFID system components is preferably positioned on the same surface of the disk structure.

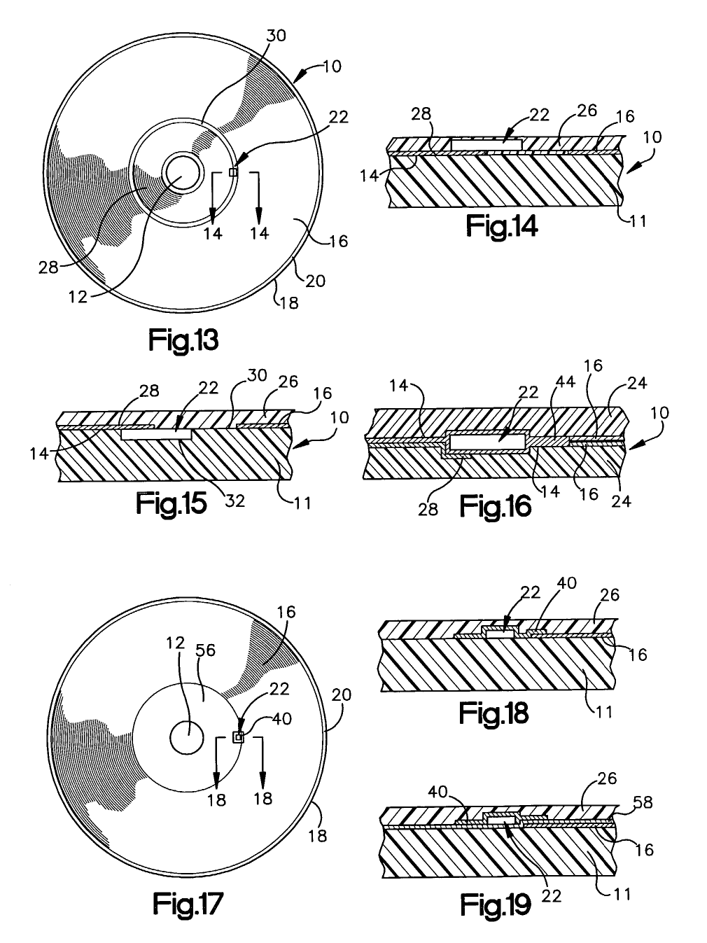

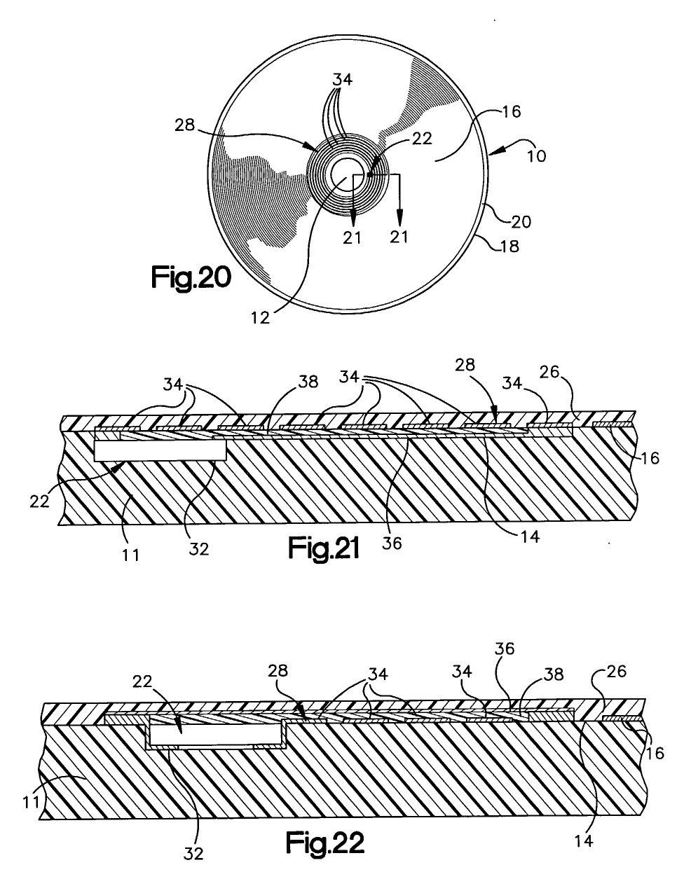

Both capacitive and inductive antenna systems can be utilized with the processor 22. A disk 10 utilizing a capacitive antenna system is shown in FIGS. 1-10 and 12. With the capacitive antenna system, one terminal of the dipole processor 22 is electrically coupled to the antenna 28, and the other terminal is electrically coupled to the metalized data storage area 16. With an inductive antenna system, as shown in FIGS. 13-30, the two terminals of the RFID processor 22 are electrically coupled to the two poles of the antenna. With either type of antenna system, the antenna 28 may be formed by depositing metal, such as by sputter coating or hot foil stamping, or printing a conductive material, such as a polymer or ink, on the surface 14 of the disk base 11. Alternatively, the antenna 28 may be formed by adhesively attaching a preformed antenna, or by attaching a preformed tag, which includes both the processor and the antenna, on the disk surface 14. The antenna may be shaped as a solid annular area of conductive material, as shown in FIGS. 1, 11, 12 and 13, or may be formed as a more defined shape, such as a spiral, a coil, a loop, or an arm, examples of which are shown in FIGS. 20, 23, 26 and 29-30. Alternatively, the outer metalized data storage area may be used as an antenna, without requiring the deposit of conductive material in the inner area. The processor and antenna are embedded within the disk structure so that they form an integral part of the disk 10.

In forming varied shapes, such as a coil, loop, or spiral, the center of the disk is metalized and the antenna pattern may be cut into the metalized area using etching, laser ablation, or mechanical or chemical removal. A shaped antenna may also be formed using sputter coating, hot foil stamping, plating or other known techniques for forming shaped patterns of materials on surfaces. The antenna 28 may be deposited by printing with highly conductive ink on the disk surface 14, such as ink manufactured by Dupont. A shaped antenna may also be formed by masking off parts of surface 14, depositing material over the maskings and surface 14, and removing the maskings. With each of these systems, the RFID components may be covered with a protective coating after they are applied to the surface. The coating may be an acrylic, a nitrocellulose, or another suitable material as known by those of skill in the art.

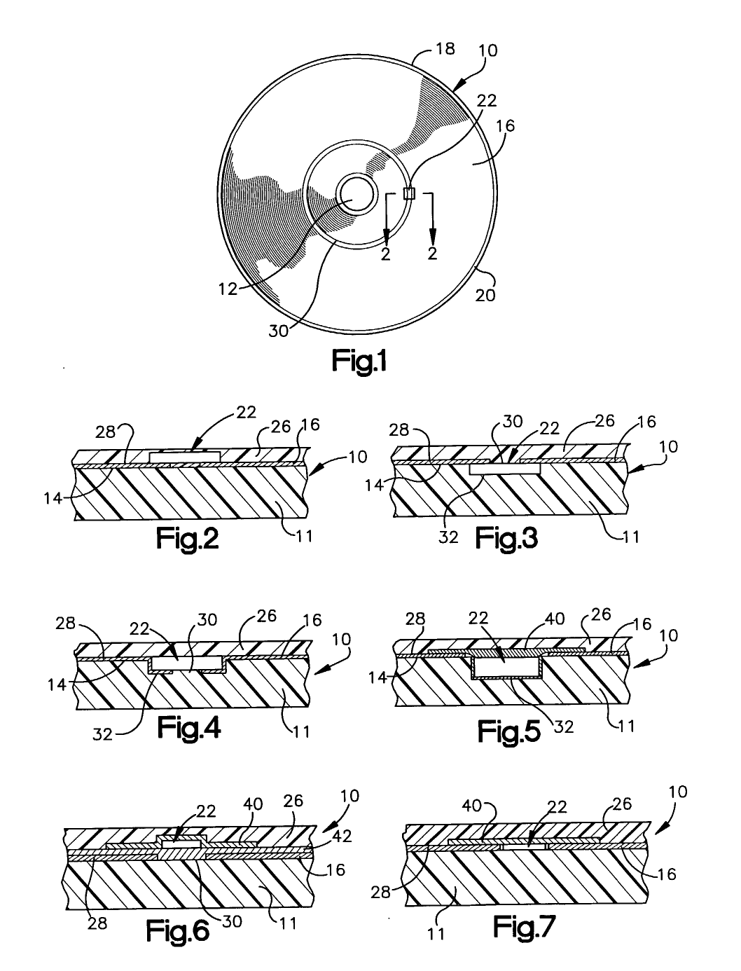

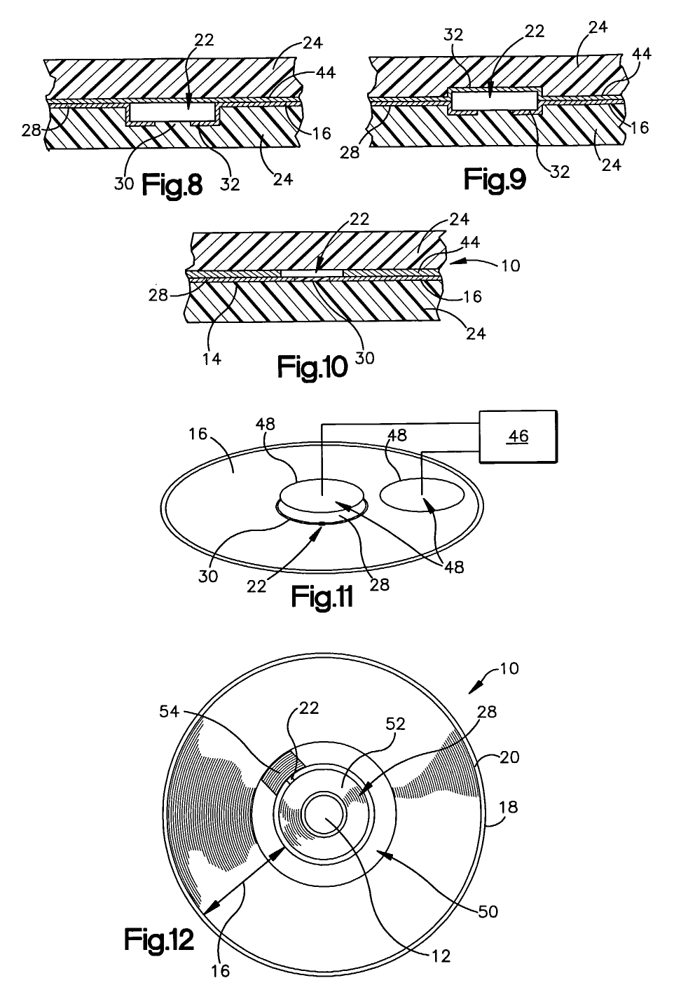

FIGS. 1-10 depict a capacitive processor 22 positioned on the surface 14 of the disk base 11 in the gap 30 in a variety of configurations. FIGS. 2-7 represent a CD construction and FIGS. 8-10 represent a DVD construction. As shown in FIG. 2, the inner 28 and outer 16 metalized areas are positioned on the disk surface 14 and the processor 22 is positioned on the metalized areas. A layer of adhesive or other adhering material may be positioned under the processor 22, or the processor 22 may simply be positioned over the metalized areas so that a space is formed under the processor 22. The electrical connection between the processor 22 and the inner 28 and outer 16 metalized areas may be established by positioning each of the terminals on one of the inner 28 or outer 16 metalized areas. The connection may be physical, where the terminals are physically connected to the conductive areas (as shown in FIG. 2), or may be capacitive, where a non-conductive layer is positioned between the processor and the metalized areas. The physical connection may be provided by attaching a lead (not shown) from each of the metalized areas to the terminals, or vice versa. The physical connection may also be established by positioning the terminals of the processor directly on the metalized areas.

In FIG. 3, the processor 22 is recessed into the surface 14 of the disk 10 while the antenna 28 and metalized area 15 are positioned on top of the surface 14 of the disk base 11. The processor may be recessed by either creating a recess 32 in the surface 14 and positioning the processor 22 in the recess 32, or by pressing the processor 22 into the surface 14 so that it sinks into the surface 14 during the disk molding process. With the former, the recess 32 may be formed either during molding of the disk 10 or after the disk is formed by removing material utilizing a known technique. Several methods for forming a recess 32 in the disk surface after the annular disk 10 is created are laser ablation, or mechanical or chemical removal. The recess 32 is preferably of a size sufficient to accept the processor. The processor 22 may be positioned in the recess 32 before the disk 10 is coated with a protective coating 26. An adhesive may be adhered to the processor before it is positioned in the recess 32, or may be positioned in the recess prior to insertion of the processor into the recess. An adhesive is optional and may be conductive. After the processor is positioned in the recess, the antenna 28 and/or outer metalized data storage area 16 may be positioned on the surface 14 so that they physically contact the terminals of the processor. Alternatively, if the antenna 28 and metalized data storage area 16 are already positioned on the surface 14, conductive leads or traces may be formed on the processor 22 and surface 14 to create an electrical coupling. The surface of the disk, including the processor, antenna, and metalized data storage area, may then be coated with a protective coating 26, as discussed above.

FIG. 4 depicts a processor 22 positioned in a recess 32, but with the conductive poles from the antenna 28 and metalized data storage area 16 extending into the recess for electrical coupling to the terminals of the processor 22. The recess 32 may be formed before the surface 14 is metalized so that the metalized layer of the data storage area 16 and the inner metalized area 28 may extend into the recess 32. Alternatively, leads or traces may extend from the metalized area 16, 28 into the recess to connect the metalized areas 16, 28 to the recess 32 for coupling to the processor 22.

FIGS. 5-7 show a system that utilizes an interposer 40 in addition to the processor 22. In FIG. 5, the processor 22 is positioned in a recess 32 and the interposer 40 covers the processor 22 and electrically couples the processor 22 to the antenna 28 and the metalized data storage area 16.

FIG. 6 depicts a non-conductive layer 42 positioned over the antenna 28, gap 30, and metalized data storage area 16. An interposer 40 is positioned over the non-conductive layer 42 so that the interposer 40 extends partially over the antenna 28 and metalized data storage area 16. The processor 22 is positioned under the interposer 40 in the gap 30 area and is surrounded by the non-conductive layer 42. The processor 22 may be embedded in the non-conductive layer 42. The components are covered by a protective coating 26. The electrical connection between the processor 22, antenna 28, and metalized data storage area 16 is established capactively.

FIG. 7 is similar to FIG. 6, except the interposer 40 is positioned directly in contact with the antenna 28 and metalized data storage area 16 to create a direct electrical connection. The processor 22 is positioned in gap 30 between the metalized data storage area 16 and the antenna 28. The interposer 40 is positioned over the processor 22 and is in electrical contact with the processor 22. The interposer is also in electrical contact with the antenna 28 and metalized data storage area. The interposer 40 may be attached to the outer 16 metalized area or antenna 28 using an adhesive or other adhering medium. The processor 22 may be positioned in gap 30 with an adhesive and gaps may be positioned around the processor. The processor is not in direct electrical association with the antenna 28 and metalized data storage area 16. If the interposer is flexible, it may conform to the surfaces below it, so as to slightly fill in any gaps surrounding the processor.

While the processor 22 is shown positioned under the interposer 40 in FIGS. 6 and 7, it may alternatively be positioned on top of the interposer 40 (not shown). When the processor 22 is positioned on top of the interposer 40, it may be applied by an adhering medium, such as a conductive adhesive. The space under the interposer 40 in gap 30 may be filled with a non-conductive material, such as a polymer or adhesive, or may remain unfilled such that an air space is created under the interposer 40. If the interposer 40 is flexible, it may conform to the space in gap 30 such that the air space is minimized.

Alternatively, the processor 22 may be positioned in a recess 32 after the annular disk 10 is coated with a protective coating 26. This may occur by pressing the processor into the coating material while the material is soft, or by forming a recess into the protective coating 26 and positioning the processor 22 in the recess 32. After the processor 22 is positioned in the recess 32 formed in the protective coating 26 (not shown), the recess 32 and processor 22 may be covered with an additional protective material, which may be the same type of material as the protective coating 26, or a different type of material. Thus, while many of the embodiments described and shown herein depict the processor embedded in surface 14, the processor may also be embedded in or positioned on the protective coating 26.

It should be noted that the antenna 28 may also be recessed below the surface 14. The antenna may be recessed by any of the techniques discussed above, in addition to other known techniques.

FIGS. 8-10 depict a DVD construction of the disk 10. As discussed above, a DVD includes two disk layers 24 and the processor 22 may be bonded between the layers, or positioned on an exterior surface of one of the disk layers. FIG. 8 depicts a processor 22 positioned in a recess 32 formed in one of the disk layers 24. Leads to the antenna 28 and metalized data storage area 16 extend into the recess in order to establish a connection between the processor and metalized areas. A layer of bonding material 44, such as a lacquer, is shown positioned between the upper layer 24 and the lower layer 24. This bonding material 44 may fill in any gaps around the processor 22 in the recess 32. FIG. 9 is a view similar to FIG. 8, except a recess 32 is positioned in both the upper and lower layers 24. FIG. 10 differs from FIGS. 8 and 9 in that it does not utilize a recess. Instead, the processor 22 is embedded in the layer of bonding material 44. In this embodiment, a small space may remain under the processor 22 in gap 30. This space may be filled by the bonding material 44 or other filler material. Alternatively, this space may be left unfilled so that a small air space is created under the processor 22. In addition, the processor 22 may be pressed into one or both of the surfaces 14 of the disk layers 24 during manufacture of the disk layers 24 so that a recess 32 does not have to be separately formed. While not shown, an interposer 40 can be used with any of the described embodiments.

FIG. 11 depicts a schematic of a reader 46 positioned in close proximity to the disk 10 of FIGS. 1-10. The processor 22 on the disk has two terminals and is positioned in gap 30. It has one terminal electrically coupled to the inner metalized area 28 and another terminal that is electrically coupled to the outer metalized data storage area 16. The reader 46 includes two coupling plates 48, one of which is positioned over the inner metalized area 28 and the other of which is positioned over the outer metalized data storage portion 16. This reader and antenna arrangement can be used with a capacitive or inductive chip.

FIG. 12 depicts a different embodiment of the claimed invention, where an interposer tag 50 that is circular is positioned in the interior portion of the disk 10 around central opening 12. The interposer tag 50 includes a conductive patch 52 arranged concentrically that substitutes for antenna 28 on the disk surface 14. Interposer tag 50 also includes a conductive pad 54 for electrically coupling to the outer metalized data storage area 16. A processor 22 is positioned between conductive patch 52 and conductive patch 54 and is electrically coupled to both patches. Patch 54 serves as the interposer between the processor 22 and the metalized data storage area 16. Interposer tag 50 may be positioned directly on the disk surface 14 and may be adhesively applied, if desired. A protective layer 26 may then be coated onto the disk surface 14 and tag 50. While the interposer tag 50 is depicted and described as circular, it may take on other shapes, as desired.

Referring to FIG. 13, a disk 10 having an inductive antenna system is shown. The processor 22 is positioned partially in the gap 30, and has one terminal that is connected to the inner antenna portion 28. The inner antenna portion 28 in FIG. 3 is shown as being a solid block of conductive material. However, as previously discussed, antenna portion 28 may take on other shapes and is not limited to the shape shown. A second terminal of the processor may be associated with an onboard antenna on the processor (not shown). Alternatively, the processor does not have another antenna associated with the other terminal. Instead, a reader may obtain a reading from the processor utilizing a touch mode, where the reader touches the disk in the vicinity of the processor. FIGS. 14-16 are similar to FIGS. 2-4 and 9, discussed above, but instead of being connected to both the data storage area 16 and the antenna 28, they are not electrically coupled to the data storage area 16. The connections described above in connection with FIGS. 2-10 are also applicable to FIGS. 14-16.

FIGS. 17-19 depict an alternative embodiment of an inductive antenna system where only an outer metalized area 16 is provided. The inner area 56 of the disk surface 14 is free of conductive material. In this embodiment, the processor 22 is positioned in the non-conductive inner area 56 and is coupled to an interposer 40. One side of the interposer 40 extends into the non-conductive inner area 56 and the other side of the interposer is electrically coupled to the metalized data storage area 16. The interposer 40 may be in physical contact with the metalized data storage area 16, as shown in FIG. 18. Alternatively, the interposer 40 may be spaced from the metalized data storage area 16, as shown in FIG. 19, by a non-conductive layer 58, but capacitively coupled with the metalized data storage area 16. Non-conductive layer 58 may be an acrylic or other non-conductive material, as known by those of skill in the art. With this embodiment, a reader can read the chip either capacitively, or by physically touching the disk in the vicinity of the outer edge of the interposer 14.

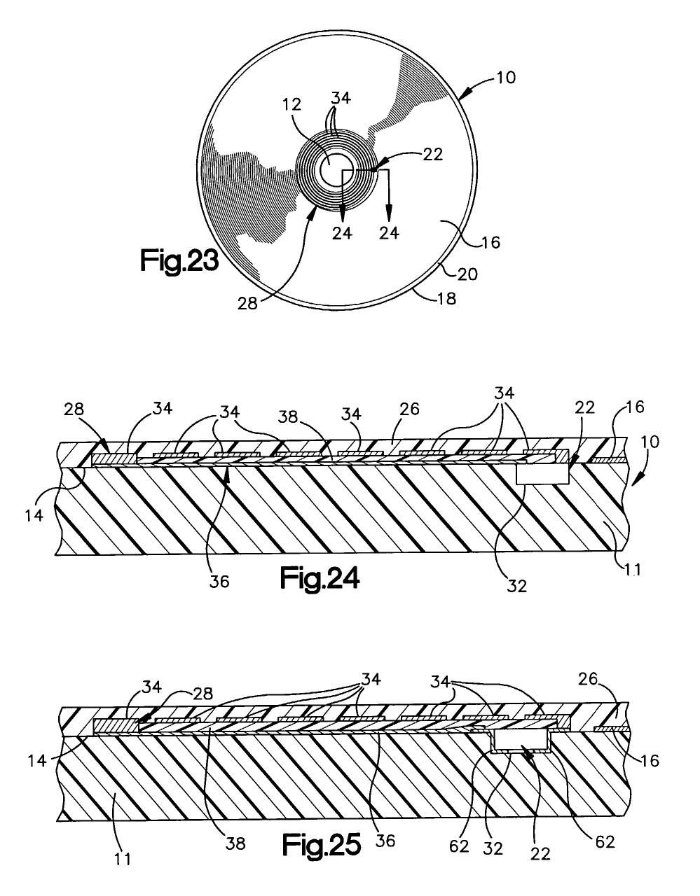

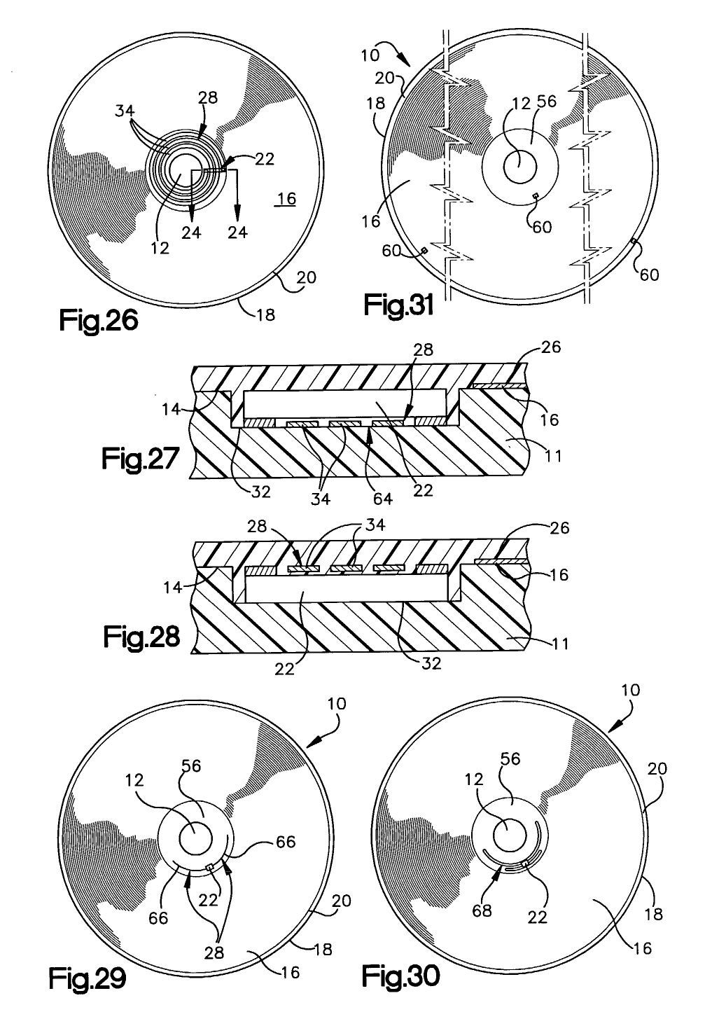

FIGS. 20-28 also depict a disk having an inductive antenna system, of the spiral, coil, or loop variety. FIGS. 20, 23 and 26 differ from one another in the placement of the processor 22 in relation to the antenna 28. In FIG. 20, the processor 22 is positioned radially inwardly from the antenna 28, in the vicinity of the central opening 12. In FIG. 23, the processor 22 is positioned between the antenna 28 and the data storage area 16, and FIG. 26 shows the processor 22 positioned over or under the antenna 28.

Referring to FIGS. 20-22, the processor 22 is positioned on the disk surface 14 near the central opening 12 and has two terminals, each of which are coupled to one pole of the antenna 28. The antenna has a plurality of loops 34, which wind around one another. The loops wind away from the central opening 12. One pole of the loop 34 bridges the inner antenna coils 34 with a bridging connector 36 to connect the pole of the antenna 28 to the processor 22. The bridging connector 36 may be electrically isolated from the inner antenna loops 34 by an insulating dielectric 38, and the outer inductive loops 34 may be isolated from one another by the protective coating 26 or a different non-conductive material positioned over the bridging connector. Furthermore, the insulating dielectric 38 may be the same material as the protective coating 26. FIG. 21 depicts the processor positioned in a recess 32, with the antenna 28 positioned over the processor. The bridging connector 36 is in physical contact with the processor 22 at one pole and the antenna 28 at the other pole. The antenna 28 is positioned over the bridging connector 36. FIG. 22 differs from FIG. 21 in that the antenna is positioned directly on the disk surface 14, so that the bridging connector 36 spans over the antenna loops 34.

FIGS. 23-25 depict a disk similar to that of FIGS. 20-22, but with the processor 22 positioned between the antenna 28 and the metalized data storage area 16. The processor 22 has two terminals, each of which is attached to one pole of the antenna loop 34. With this embodiment, in order to contact the second terminal of the inductive processor 22, the antenna loop 34 closest to the disk central opening 12 bridges the outer antenna loops 34 with a bridging connector 36 without electrically contacting the loops. The bridging connector 36 may be electrically isolated from the outer antenna coils 34 by utilizing an insulating dielectric 38. FIG. 24 shows the processor positioned in a recess 32, with the antenna 28 positioned over the processor 22. The bridging connector 36 is in physical contact with the processor 22 at one pole, and the antenna 28 at the other pole. The antenna 28 is positioned over the bridging connector 36 and an insulating dielectric 38 is positioned between the coils 34 and the bridging connector 36. The insulating dielectric may be any type of insulating material, including the same material as the protective coating 26.

FIG. 25 differs from FIG. 24 in that leads 62 are connected to the processor 22. The leads 62 are electrically coupled with the processor, the antenna 28, and the bridging connector 36. As shown in both FIGS. 24 and 25, the protective coating 26 may serve as an insulator between the respective loops 34 of the antenna 28.

FIGS. 26-28 depict a different inductive antenna system where the processor 22 is positioned either over or under the loops 34 of the antenna 28. Because the antenna loops 34 are positioned directly over or under the processor 22, a bridging connector 36 is not required. FIG. 27 depicts the processor 22 positioned in a recess 32 in the surface 14 of a CD structure. The antenna 28 is positioned under the processor 22 in the recess 32. Since the antenna 28 is a spiral loop, the recess 32 in this case will preferably extend annularly around the central opening 12. The processor 22 is coupled with the ends of the spiral at its terminals. The antenna loops 34 in the intermediate areas 64 of the loops 34 are separated by a non-conductive material. FIG. 28 is similar to FIG. 27, except the antenna 28 is positioned over the processor 22 in a recess 32. It should also be noted that the recess 32 is not required. The antenna and processor could be deposited directly on surface 14. Alternatively, as discussed with several embodiments above, the processor 22 or antenna 28 could be pressed into the disk surface 14 during manufacture of the disk, or positioned in a recess formed on the protective coating 26.

FIGS. 29 and 30 show different antenna configurations. FIG. 29 shows a processor 22 with an associated dipole antenna 28 that has antenna arms 66 extending outwardly from the two terminals of the processor 22. The processor 22 and dipole antenna 28 may be positioned directly on the surface 14 of the disk 10 in the interior area 56 of the disk by any of the means for deposit discussed above. The interior area 56 is preferably free from conductive material, other than that associated with the antenna arms 66 and processor 22. The dipole antenna may vary in size, with the example shown in FIG. 29 being for illustration purposes only. Furthermore, either or both of the antenna 28 and the processor 22 may be positioned in a recess 32 defined on surface 14. Alternatively, the processor 22 and dipole antenna arms 66 may be positioned on a tag, which can be adhesively, or otherwise applied to the surface 14 of base 11. The surface 14 is coated with a protective coating so that the antenna 28 and processor 22 are integral with the disk structure.

FIG. 30 is similar to FIG. 29, but shows a folded dipole antenna 68 associated with processor 22 in the inner non-conductive area 56. As discussed above for FIG. 29, the processor 22 and/or antenna 68 may be positioned on the disk surface 14 of base 11, in a recess 32 defined in the disk surface 14, or as a stand alone tag positioned on the disk surface 14 that is adhesively or otherwise applied.

FIG. 31 depicts a processor 60 that has an onboard antenna positioned on the disk 10. With this embodiment, it is not necessary to have a separate antenna defined on the disk surface 14, since the antenna is integral with the processor 60. However, it may be beneficial to have the processor 60 associated with a separate antenna in order to augment the range of the processor. Three different placements for processor 60 are shown in FIG. 31, including in the inner non-conductive area 56, the outer non-conductive area 20, and under the metalized data storage area 16. When the processor 60 is positioned in the metalized data storage area 16, it is preferably positioned in a part of the area 16 that is free of data, such that the metal layer of the metalized data storage area covers the processor 60, but the processor does not interfere with the data on the disk 10. With this embodiment, the metal layer serves as an additional antenna to boost the signal of the processor 60. As with other embodiments, the processor 60 may be embedded in a recess 32 (not shown). In addition, the processor 60 may be covered with a non-conductive material prior to having the metalized layer positioned over the processor. The processor may also be covered with a conductive material when it is positioned in the inner non-conductive area 56. The conductive material may be shaped in an antenna pattern and may be utilized by the processor 60 to augment the range of the processor 60.

With respect to the antenna 28, the antenna may be a single layer of conductive material that is positioned on the disk surface 14 or in a recess 32. Alternatively, it may be a metallic layer or a print deposited layer of conductive ink or other conductive material. The antenna 28 may be positioned above or below the protective coating 26.

The process utilized to enable an information disk with an RFID processor includes molding the base 11 of the disk 10 and forming the data portion on the disk surface 14 in a generally concentric manner near the outer periphery 18 of the disk 10. A small non-conductive ring 20 remains at the outer periphery 18, where data is not stored. The data portion is then metalized by applying a thin layer of metal over the data portion to form the metalized data storage area 16. This may be accomplished by techniques known by those of skill in the art.

The inner part of the disk may remain partly or wholly unmetalized or may be metalized to form an antenna 28 on the disk surface 14. In one embodiment of the process, the inner area is metalized to form a conductive annular area near the center of the disk 10. When an opening 12 is provided in the disk 10, the inner metalized area 28 surrounds the center opening 12, but may be slightly spaced from the opening. This inner metalized area 28 may be formed using sputter coating, hot foil stamping, or other metal depositing techniques. Alternatively, an antenna portion 28 may be print deposited on the surface 14 in the inner area of the disk base 11 using a conductive material, such as conductive ink. The inner metalized area 28 is preferably conductive and may be shaped as a solid ring-shape, or in a pattern, such as a spiral, loop, coil, arms, or other shapes.

A gap 30 is positioned between the inner 28 and outer 16 metalized areas, and a processor 22 is positioned at least partially in the gap 30 so that the processor 22 is electrically active. The processor 22 may be electrically coupled to either or both of the inner 28 and outer 16 metalized areas. The disk surface 14 may then be coated with a protective coating 26. This coating 26 preferably covers the inner metalized area or antenna 28, the processor 22 and any associated leads, and the metalized data storage area 16.

The process may also include forming a recess 32 in the disk surface 14 at the gap 30. The recess 32 is preferably sized to accept a processor 22 therein. Alternatively, a larger recess 32 may be formed to accept both the processor 22 and the antenna 28. The processor 22 and/or antenna 28 are positioned in the recess 32. The processor 22 and/or antenna 28 may include an adhesive for adhering them to the surface 14. Alternatively, the processor 22 and antenna 28 may be positioned on a tag that can be positioned on the surface 14 of the base 11. This tag may be positioned in a recess 32 formed on the surface 14 of the base 11 and may include an adhesive for attaching the tag to the surface 14. The tag may be positioned partially in the gap 30 and partially in the inner antenna portion 28.

A coating 26 may be applied over the recessed area 32 to fill in any gaps around the antenna 28 or processor 22 that remain after the processor 22 and/or antenna 28 are positioned in the recess 32. The entire surface 14 of the disk, including any RFID components, may be coated with the protective coating 26.

The recess 32 may be formed during manufacture of the disk base 11 during the compression molding process, so that the recess is integrally formed with the base 11. Alternatively, the recess 32 may be formed after the base 11 is created in the molding process. The recess 32 may be formed by laser ablation, or mechanical or chemical removal, among other known techniques for forming a recess in a plastic material.

The metalized areas 16, 28 on the disk may be formed at the same time as one another. For instance, an annular ring area on the disk surface 14 may be masked by an appropriate masking agent and the disk surface 14 may then be metalized. Upon removal of the masking material, a gap 30 is formed between the inner 28 and outer 16 metalized areas. Alternatively, the entire inner portion of the disk surface 14, including the gap 30, may be masked and then the disk surface 14 is metalized to create the outer metalized data storage area 16. The mask may be removed to reveal a non-conductive inner area. Separate applications may be applied to the inner area to form an antenna 28 on the inner area, if desired, such as print depositing a conductive material, or depositing a metal by sputter coating, hot foil stamping, or other known techniques for depositing metal on a plastic surface. In another embodiment, the entire disk surface 14 is metalized and the metalized surface is cut to form the gap 30 and/or a shaped antenna. Another embodiment involves masking the inner portion in the shape of an antenna, depositing a conductive material over the inner portion, and removing the masking to reveal a shaped antenna 28 in the inner portion. The gap 30 and antenna shape may be cut using a technique such as laser ablation, etching, or mechanical or chemical removal, among other known techniques.

The processor may be electrically coupled to either or both of the inner 28 and outer 16 metalized areas. In one embodiment, the processor 22 is a chip and the terminals of the chip span the gap 30 and establish an electrical connection with the inner 28 and outer 16 metalized areas. In another embodiment, the processor 22 is positioned in the gap 30 and leads are utilized to connect the processor terminals to the inner and outer metalized areas. In yet another embodiment, the processor 22 is positioned on an interposer 40, and the interposer 40 is in electrical contact with the inner 28 and outer 16 metalized areas. Some embodiments of the invention do not require an electrical connection with both the inner 28 and outer 16 metalized areas. For instance, in one embodiment, the processor 22 is positioned in the inner area, which is non-conductive, and is electrically coupled to the outer metalized data storage area 16, as shown in FIGS. 17-19. In another embodiment, the processor 22 is only electrically coupled to the inner antenna portion 28, as shown in FIGS. 13-16 and 20-30, not to the outer metalized data storage area 16.

When a loop, or other shape having two poles, is utilized for the antenna portion 28, the poles of the loops are preferably electrically coupled to the terminals of the processor 22. Where the antenna 28 is a spiral shape having loops that wind around each other, a bridging connector 36 may be utilized to establish a connection between one end or pole of the loop and the processor 22, while the other end or pole of the loop may be directly coupled to the processor 22 without the use of a bridging connector 36.

In the preferred embodiments, as shown in the Figures, the RFID processor is passive. However, a semi-passive or active system is also contemplated for use with the present design. If a semi-passive or active processor is utilized, a battery (not shown) is positioned on the surface of the disk.

A variety of commercially available processors are contemplated for use with the claimed invention, including both capacitive processors and inductive processors. Some commercially available processors include the Bistatix chip by Motorola, or chips manufactured by Phillips or Hitachi, among others. These chips may be positioned at any number of locations on the disk, such as those described above. Other types of processors that may be utilized include those where one terminal of the processor is connected to the metalized data storage area 16 and the other terminal of the processor is connected to an antenna provided integrally on a tag with the processor. Furthermore, as discussed above, a processor with an onboard antenna may also be utilized.

Conductive leads, traces, or other conducting elements may be utilized, as discussed above, to establish an electrical connection between the processor 22 terminals, antenna 28, and metalized data storage area 16. These leads may be any type of conductive material known to those of skill in the art, such as conductive adhesive, conductive polymer, or solder.

It should be noted that processor 22 may be installed either upright or upside down. A processor 22 may be installed upside down prior to metalization or printing of conductive ink. This would allow the antenna to be built over the processor instead of under the processor and would eliminate the need for a conductive adhesive or solder to attach the processor to the antenna. In some cases, it may be necessary to position the processor such that the chip on the processor faces the reader.

It should also be noted that while specific examples of CDs and DVDs are described above, the claimed invention is not limited to the specifically described embodiments. In particular, the dimensions provided above are for illustration purposes only. While the disks are shown and discussed as being annular, non-annular disks may also be utilized. In addition to the types of CDs and DVDs described above, other types of CDs and DVDs are also contemplated to be used with the claimed invention, such as CD-ROM, CD−R, CD−RW, DVD-ROM, DVD−R(G), DVD−R(A), DVD−RW, DVD-RAM, DVD+RW, and DVD+R, among others. Further, different DVD formats may be utilized with the claimed invention, in addition to those with dual layers, including DVD-5 (single side, single layer), DVD-9 (single side, dual layer), DVD-10 (double side, single layer), DVD-14 (DVD-5 single layer bonded to a DVD-9 dual layer) and DVD-18 (two bonded DVD-9 dual layer structures).

While disks having certain layer thicknesses are shown in the figures, it should be noted that the various relative thicknesses are for illustration purposes only. The actual disk structures may vary from the sizes and relative dimensions shown herein. Also gap 30 may vary in size. For example, gap 30 may be large enough to accept the size of a processor. In contrast, it may be small enough so that the terminals of a chip span the gap 30 to electrically couple the chip to both the antenna 28 and the metalized data storage area 16, among other sizes.

It should be further noted that a reader is utilized to read the processor once installed on the disk surface 14. With some of the above-discussed embodiments, a reading of the processor may require physical contact between the reader and the disk 10. In other embodiments, physical contact between the reader and the disk is not required. Whether direct contact is necessary will depend on a number of factors, including antenna shape and size, and processor positioning and characteristics, among other things.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are examples of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. An information disk comprising:
an annular disk structure having a surface with a metalized data storage area coupled to the surface for storing information;
an antenna coupled to said annular disk surface positioned radially inwardly from the metalized data storage area;
a radio frequency identification processor coupled to said annular disk surface and the antenna; and
a protective coating coupled to at least one of the processor or the antenna.

2. The information disk of claim 1, wherein the protective coating is positioned over the disk structure covering the metalized data storage area, antenna, and processor.

3. The information disk of claim 1, wherein the processor is positioned between the metalized data storage area and the antenna.

4. The information disk of claim 1, wherein the processor is positioned radially inwardly from the antenna.

5. The information disk as defined in claim 1, wherein said processor is configured for cooperation with a dipole antenna system and has two terminals, with one of said terminals electrically connected to said antenna and the other of said terminals electrically connected to said data storage area.

6. The information disk as defined in claim 1, wherein the processor is a dipole inductive processor that is electrically coupled to the metalized data storage area and the antenna.

7. The information disk as defined in claim 6, wherein a gap is positioned between the metalized data storage area and the antenna, and the inductive processor is positioned at least partially in the gap.

8. The information disk as defined in claim 1, wherein said processor is configured for cooperation with an inductive antenna system and has two terminals, with said antenna having first and second poles, each pole being electrically connected to one of the terminals of said processor.

9. The information disk as defined in claim 1, wherein the processor has two terminals and is positioned radially inwardly from the antenna and the antenna is a loop having a first and a second pole, and the first and second poles of the loop are electrically coupled to the two terminals of the processor.

10. The information disk as defined in claim 8, further comprising an opening in the center of the annular disk structure, with the antenna encircling the opening, wherein the processor is positioned between the antenna and the opening on the disk surface.

11. The information disk as defined in claim 8, further comprising an opening in the center of the annular disk structure, with the antenna encircling the opening, wherein the processor is positioned between the antenna and the metalized data storage area on the disk surface.

12. The information disk as defined in claim 8, wherein the first pole is connected to one of the terminals of the processor and the second pole has a bridging connector that bridges a portion of the antenna and couples with the other terminal of the processor.

13. The information disk as defined in claim 12, further comprising an insulating dielectric positioned between the antenna and the bridging connector.

14. The information disk as defined in claim 1, wherein the antenna is a metalized area on the disk surface and the processor is a dipole inductive processor, wherein one terminal of the inductive processor is electrically coupled to the antenna, and the other terminal of the inductive processor is electrically coupled to the metalized data storage area.

15. A system for reading an information disk, comprising:
the information disk of claim 14; and
a reader having two coupling plates, with one coupling plate configured to electrically interact with the antenna and the other coupling plate configured to electrically interact with the metalized data storage area to activate the dipole inductive processor.

16. The information disk as defined in claim 1, wherein the antenna comprises at least one of a metal, an electrically conductive ink, or an electrically conductive polymer.

17. The information disk as defined in claim 1, wherein the annular disk surface has a recess defined therein, and at least one of said processor and said antenna is positioned in the recess.

18. The information disk as defined in claim 1, wherein both said processor and said antenna are embedded within said annular disk surface.

19. The information disk as defined in claim 1, wherein said annular disk structure includes two annular disk layers, the processor and antenna are fixed between the two annular disk layers, and the non-conductive coating is positioned between the two disk layers.

20. The information disk as defined in claim 19, wherein the annular disk layers each include a recess and the processor is positioned in the recesses.

21. The information disk as defined in claim 1, wherein the antenna is one of a dipole antenna or a folded dipole antenna.

22. The information disk as defined in claim 21, wherein the antenna and processor are integrally formed as a tag positioned on the disk surface radially inwardly from the metalized data storage area.

23. The information disk as defined in claim 1, wherein said information disk is one of a CD-ROM, a CD−R, a CD−RW, a DVD-ROM, a DVD−R(G), a DVD−R(A), a DVD−RW, a DVD-RAM, a DVD+RW, and a DVD+R.

24. The process as defined in claim 1, wherein said disk is polycarbonate and the coating is acrylic or nitrocellulose.

25. A process of enabling an information disk with a radio frequency identification processor comprising:
providing a disk having a disk surface with an outer metalized data storage portion and an inner antenna portion, with said inner and outer portions being separated by a gap for accommodating a radio frequency identification processor;
positioning said processor in said gap such that said processor is electrically active;
coating said disk surface with a coating to cover said disk surface.

26. The process as defined in claim 25, wherein the coating step comprises coating at least the antenna portion, the gap, the processor and the metalized data storage portion.

27. The process as defined in claim 25, further comprising:
forming a recess in the disk surface at the gap, the recess being dimensioned for receiving said processor; and
positioning the processor in the recess.

28. The process as defined in claim 27, wherein the coating fills the recess.

29. The process as defined in claim 27, further comprising forming the disk by a compression molding process such that said recess is integrally provided in said disk surface.

30. The process as defined in claim 27, further comprising forming a recess in said disk after the disk is formed.

31. The process as defined in claim 25, wherein the providing step includes print depositing the antenna portion on the disk with a conductive material.

32. The process as defined in claim 25, wherein the providing step includes masking a central portion of the disk, metalizing the disk to form the outer metalized data storage portion, and removing the masking to reveal an unmetalized central portion and the gap.

33. The process as defined in claim 32, wherein the providing step further comprises printing a conductive material onto the central portion of the disk to provide the inner antenna portion.

34. The process as defined in claim 32, wherein the providing step further comprises depositing a conductive material in the central portion of the disk to provide the inner antenna portion.

35. The process as defined in claim 25, wherein the providing step includes masking an annular ring portion of the disk, metalizing the disk to form the outer metalized storage portion and the inner metalized portion, and removing the masking to reveal the gap, and further comprising cutting a pattern into the inner metalized portion to form a shaped antenna portion.

36. The process as defined in claim 25, wherein the providing step includes masking an annular ring portion and a part of the antenna portion of the disk, metalizing the disk to form the outer metalized storage portion and the inner metalized antenna portion, and removing the masking to reveal both the gap and the antenna portion, wherein the antenna portion is masked in a predetermined pattern to form a shaped antenna portion once the masking is removed.

37. The process as defined in claim 25, wherein the providing step includes providing a disk, metalizing the disk to form a metalized surface that includes the outer metalized data storage portion and the antenna portion, and removing an annular ring portion of the metalized surface to define a gap between the outer metalized data storage portion and the antenna portion.

38. The process as defined in claim 37, wherein the removing step includes utilizing a laser after metalization to remove the annular ring portion of the metalized surface.

39. The process as defined in claim 25, wherein the providing step includes positioning the antenna portion and processor on a single tag and positioning the tag partially in the gap and partially in the inner antenna portion.

40. A process of enabling an information disk with an RFID processor comprising:
providing an annular disk having an annular surface with an outer metalized data storage portion and an inner antenna portion, with said inner and outer portions being separating by a non-conductive gap, with the gap being dimensioned to accommodate a radio frequency identification processor;
positioning the processor radially inwardly from the antenna portion on the disk surface such that the processor is electrically coupled to the antenna;
coating the disk with a coating to cover the disk surface.

41. The process of claim 40, wherein the processor has two terminals and the antenna portion is a loop with two poles, with one of the terminals being coupled to one of the poles, and the other of the terminals being coupled to the other pole.

42. A process of enabling an information disk with a radio frequency identification processor comprising:
providing a disk having a surface with an outer metalized data storage portion around the outer periphery thereof and an inner portion;
positioning a loop-type antenna on the inner portion of the disk surface, said loop-type antenna having a first and a second pole;
positioning a radio frequency identification processor having a first and a second terminal in association with the loop-type antenna such that the first terminal of the processor is associated with the first pole of the loop-type antenna and the second terminal of the processor is associated with the second pole of the loop-type antenna; and
coating the disk with a protective coating.

43. The process of claim 42, wherein the second terminal of the processor is associated with the second pole of the loop-type antenna by a bridging connector positioned over the processor and the loop-type antenna.

44. The process of claim 42, wherein the coating step includes coating the data storage portion, the loop-type antenna, and the processor.

45. The process of claim 42, wherein the positioning of a radio frequency identification processor step includes positioning the processor over the loop-type antenna.

46. The process of claim 42, wherein the positioning a radio frequency identification processor step includes positioning the processor under the loop-type antenna.

47. The process of claim 46, further comprising electrically associating the processor with the loop-type antenna.

48. A process of enabling an information disk with a radio frequency identification processor comprising:
embedding a radio frequency identification processor in a disk structure;
metalizing the disk structure over the processor to form a data storage area and an antenna such that the processor is electrically associated with at least one of the data storage area and the antenna.

49. The process of claim 48, further comprising coating the disk with a coating.

50. An information disk comprising:
a rigid disk structure having a surface with a first metalized portion and a second metalized portion disposed on the surface, with a gap positioned therebetween; and
a radio frequency identification processor positioned at least partially in the gap, wherein the processor is electrically coupled to at least one of the first or second metalized portions.

51. The information disk of claim 50, further comprising an interposer associated with said processor, wherein the interposer is positioned at least partially in the gap and the processor is connected to the interposer.

52. The information disk of claim 50, wherein the disk structure is annular, with the first metalized portion being positioned near the outer periphery of the disk structure and the second metalized portion being positioned radially inwardly from the first metalized portion.

53. The information disk of claim 50, wherein the first metalized portion is a data storage area and the second metalized portion is an antenna.

54. The information disk of claim 50, wherein the processor is electrically associated with both the first metalized portion and the second metalized portion.

55. The information disk of claim 53, wherein the antenna is a loop with a first end and a second pole, and the first and second poles are electrically associated with the processor.

56. The information disk of claim 50, wherein a recess is positioned at least partially in the gap and the processor is positioned in the recess.

57. The information disk of claim 50, wherein the disk structure has two disk layers that are bonded together, and the processor is positioned between the layers.

58. The information disk of claim 50, wherein the disk structure has two disk layers that are bonded together, and the processor is embedded in an exterior wall of the disk structure.

59. The information disk of claim 50, wherein the processor is electrically associated with the first or second metalized portions by one of a solder, a conductive adhesive, a conductive polymer, a conductive ink, or contact pressure.

60. The information disk of claim 50, wherein the disk structure has an acrylic top layer and the processor is encased within the acrylic top layer.

61. An information disk comprising:
a rigid, annular disk structure having a surface with a central opening and a metalized data storage area positioned on the surface for storing information; and
a radio frequency identification processor coupled to said annular disk surface, said processor having an onboard antenna.

62. The information disk of claim 61, further comprising a protective coating covering the disk structure so that the processor is positioned under the protective coating.

63. The information disk of claim 62, wherein the processor is positioned radially inwardly from said metalized data storage area.

64. The information disk of claim 62, wherein the processor is positioned radially outwardly from said metalized data storage area.

65. The information disk of claim 62, further comprising a conductive area positioned on the disk surface between the metalized data storage area and the central opening, said conductive area having a pattern of conductive material, with said processor being electrically coupled to the conductive area.

66. The information disk of claim 62, wherein the metalized data storage area includes a portion that is data free, and the processor is positioned in the data free portion of the metalized data storage area.

67. An information disk comprising:
an annular disk structure having an annular disk surface with an outer metalized portion and an inner metalized portion, with an annular gap positioned therebetween; and
a radio frequency identification processor positioned radially inwardly from the inner metalized portion, wherein the processor is electrically coupled to the inner metalized portion.
